(19) United States
(12) Patent Application Publication
(10) Pub. No.: US 2012/0239614 A1
(43) Pub. Date: Sep. 20, 2012

(54) METHOD AND SYSTEM FOR MANAGING DATA IN DATABASE

(75) Inventors: XIN LU, Shenzhen (CN); YAO-HUA LIU, Shenzhen (CN); XI LIN, Shenzhen (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/275,325

(22) Filed: Oct. 18, 2011

(30) Foreign Application Priority Data
Mar. 18, 2011 (CN) 201110065795.0

(51) Int. Cl. G06F 7/00

(52) U.S. Cl. 707/609; 707/E17.005

(57) ABSTRACT

A method for managing data in a database includes loading data in a database to an office software based document template pre-configured in a server to generate a corresponding office software based document, and modifying and updating the data in the database through implementing a program by use of the office software based document.

### BACKGROUND

1. Technical Field

The present disclosure relates to computer technology, and more particularly, to a method for managing data in a database and a data management system.

2. Description of Related Art

Generally, a user may browse a database through a webpage browser or an application program interface. However, to update the data in the database, the user needs to access a database operation interface in order to carry out the modification. In other words, the browsing and the modification of the data in the database need to be operated through different interfaces, which is somewhat inconvenient for the user.

What is needed, therefore, is a method for managing data in a database that can overcome the described limitations; and what is also needed is a related data management system.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is a block diagram of a data management system according to an embodiment of the present disclosure.

FIG. 2 is a flowchart of a method for managing data in a database according to an embodiment of the present disclosure.

### DETAILED DESCRIPTION

Reference will now be made to the drawings to describe certain exemplary embodiments of the present disclosure in detail.

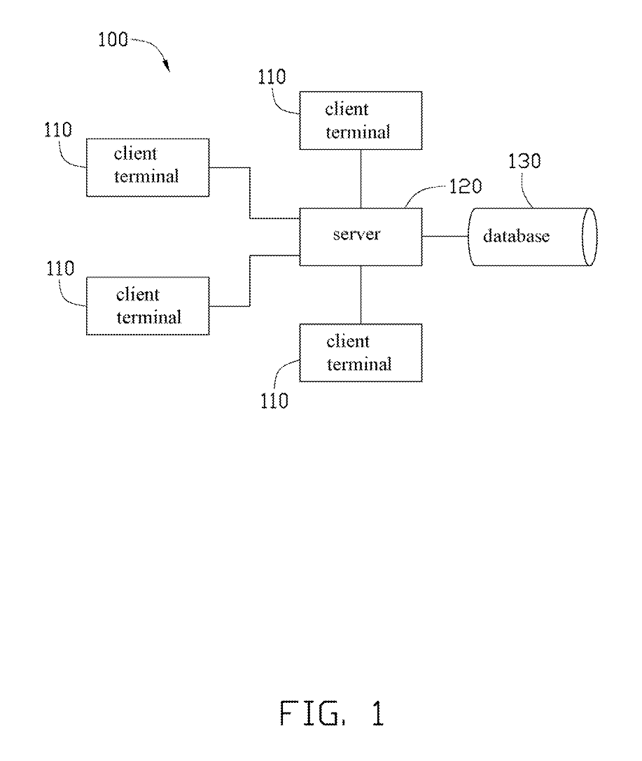

The present disclosure provides a method for managing data in a database by use of office software, to enable a user to browse and modify the data in the database conveniently. The method may be implemented in a data management system 100 as shown in FIG. 1. The data management system 100 includes a plurality of client terminals 110, a server 120 and a database 130. The client terminals 110 may be connected to the server 120 via networks, for example, the Internet or an enterprise internal network such as an intranet. The server 120 may be further connected to the database 130 through a database connection, for example, an open database connectivity (ODBC) or a JAVA database connectivity (JDBC).

In one embodiment, the database 130 may be a Structured Query Language (SQL) database or an ORACLE® database, which stores and backs up data obtained from the server 120. The server 120 may be a web-based distributed authoring and versioning server, namely, a WebDAV server, in which office software is installed. The office software may be a word processing software, such as MICROSOFT WORD® software, or a spreadsheet software, such as MICROSOFT EXCEL® software, which supports modifying the data in the database 130 through implementing a macro program by use of a visual basis for application (VBA) computer program language. The client terminals 110 may be personal computers, which provide operation interfaces for users. A user may login the server 120 through the client terminal 110, and browse and modify the data in the database 130 by use of the office software installed in the server 120.

In the data management system 100 as shown in FIG. 1, the database 130 is located separately from the server 120. It should be noted, however, that in an alternative embodiment, the database 130 may be integrated into the server 120. For example, the database 130 may be configured as an internal module within the server 120.

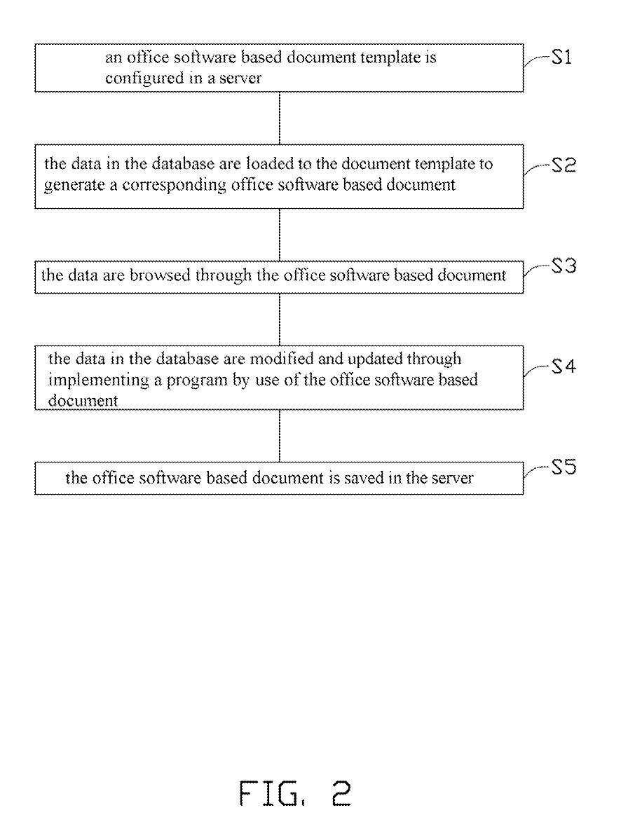

Referring also to FIG. 2, a method for managing data in a database according to an embodiment of the present disclosure is described as follows.

The method may start with step S1, wherein an office software based document template is configured in a server.

When the data are established and stored in the database 130, the user (e.g., an administrator of the database 130) may program a procedure for accessing and modifying the data in the database 130, including pre-configuring a document template corresponding to the data. The document template may be an office software based document template with a predetermined format. For example, the user may login the server 120 through the client terminal 110, and configure the document template corresponding to the data stored in the database 130 by use of the office software installed in the server 120. When the data in the database 130 need to be modified, the flow continues to step S2.

In step S2, the data in the database 130 are loaded to the document template to generate a corresponding office software based document.

For example, after the user logs in the server 120 through the client terminal 110, under the operation of the user, the server 120 may access the data in the database 130 through a webpage application program or a desktop application program, and then load the data into selected places of the document template. Thereby, a corresponding office software based document showing the data is generated. The format of the document is defined by the document template. In detail, the data in the document may be arranged in a sequence defined by the document template. For example, the data shown in the document may be arranged in multiple columns, in which a first column shows a serial number of the data, a second column shows information when the data are established or last modified, and a third column shows contents of the data.

In step S3, the data are browsed through the office software based document.

For example, the server 120 may open the office software based document, and thus the data shown in the document can be browsed by use of the office software, such as MICROSOFT WORD® or MICROSOFT EXCEL® software.

In step S4, the data in the database 130 are modified and updated through implementing a program by use of the office software based document.

When the data need to be modified, the user may compose a macro program in the office software based document to define the data modification through a visual basis for application (VBA) computer program language which is supported by the office software based document. The macro program may correlate the office software based document with the data in the database 130. Thereafter, the server 120 may implement the macro program in the office software based document according to the operation of the user to modify the data and upload the modified data into the database 130 to update the database 130.

In one embodiment, before the data are uploaded into the database 130, the server 120 may compare the data in the office software based document with the data obtained from the database 130. If the two sets of data are different, that is, the data are indeed modified, the server 130 may update the data in the database 130 though the macro program. Otherwise, that is, if the data are not modified, the server 120 may refuse to update the data in the database 130.

In step S5, the office software based document is saved in the server 120.

After the data in the database 130 have been updated, the office software based document is saved in a WebDAV catalogue of the server 120 by use of a WebDAV protocol. Moreover, the server 120 may also record information about operation on the database 130 to facilitate later management of the database 130. Such information may include a name and number of the user, and a date and contents of the data modification. Thereafter, the user may search the document according to the WebDAV catalogue of the server 120, to find the document and obtain the data modification details.

In addition, in the above-described method, different users may be assigned with different authorities, including searching, data upload, data download, data modification, and database updating. To ensure security of the data management system, only the administrator has authority to add new users, delete users or modify the authorities of the users.

It is noted that in the above-described method, the actions of the user can be performed through the server 120. The data in the database 130 can be browsed and modified by the office software based document in the server 120, without any need for operating through different interfaces, and this provides convenience for the user to manage the data.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size and arrangement of parts within the principles of the present disclosure to the full extent indicated by the broad general meaning of the terms in which the appended claims are expressed.

What is claimed is:

1. A method for managing data in a database, the method comprising:
loading data in a database to an office software based document template pre-configured in a server to generate a corresponding office software based document; and
modifying and updating the data in the database through implementing a program by use of the office software based document.

2. The method of claim 1, wherein the loading of data in a database to an office software based document template comprises:
accessing the data in the database through an application program, which is selected from a webpage application program and a desktop application program; and
loading the data in the database into selected places of the office software based document template.

3. The method of claim 2, wherein the data in the office software based document are arranged in multiple columns after the data in the database are loaded to the office software based document template.

4. The method of claim 3, wherein the office software based document comprises a first column showing a serial number of the data, a second column showing information when the data are established or modified, and a third column showing contents of the data.

5. The method of claim 1, wherein the office software is selected from a word processing software supporting program and a spreadsheet software supporting program.

6. The method of claim 5, wherein the modifying and updating of the data in the database through implementing a program by use of the office software based document comprises:
correlating the office software based document with the data in the database through a macro program in the office software based document defining data modification; and
implementing the macro program in the office software based document to modify the data and upload the modified data into the database.

7. The method of claim 6, wherein the macro program is composed through a visual basis for application (VBA) computer program language.

8. The method of claim 1, further comprising: saving the office software based document in the server, wherein the server is a web-based distributed authoring and versioning (WebDAV) server, and the office software based document is saved in a WebDAV catalogue of the WebDAV server.

9. A data management system, comprising:
a server; and
a database;
wherein, the database is configured to store data; and
the server is configured to load the data in the database to a pre-configured office software based document template to generate a corresponding office software based document, and modify and update the data in the database through implementing a program by use of the office software based document.

10. The data management system of claim 9, wherein the server accesses the data in the database through an application program which is selected from a webpage application program and a desktop application program, and loads the data in the database into selected places of the office software based document template.

11. The data management system of claim 10, wherein the data in the office software based document are arranged in plural columns after the data in the database are loaded to the office software based document template.

12. The data management system of claim 11, wherein the office software based document comprises a first column showing a serial number of the data, a second column showing information when the data are established or modified, and a third column showing contents of the data.

13. The data management system of claim 9, wherein the office software is selected from a word processing software supporting program and a spreadsheet software supporting program.

14. The data management system of claim 13, wherein the server correlates the office software based document with the data in the database through a macro program in the office software based document defining data modification, and implements the macro program in the office software based document to modify the data and upload the modified data into the database.

15. The data management system of claim 14, wherein macro program is composed through a visual basis for application (VBA) computer program language.

16. The data management system of claim 9, wherein the server is a web-based distributed authoring and versioning (WebDAV) server, and the office software based document is saved in a WebDAV catalogue of the WebDAV server.

17. The data management system of claim 9, wherein the database is selected from a Structured Query Language (SQL) database and an ORACLE® database.

18. The data management system of claim 17, wherein the server is connected to the database through a database connection, which is selected from an open database connectivity (ODBC) and a JAVA database connectivity (JDBC).

19. The data management system of claim 18, further comprising a plurality of client terminals connected to the server via one or more networks.

20. The data management system of claim 9, wherein the database is configured as an internal module within the server.
